(19) United States
(12) Patent Application Publication
(10) Pub. No.: US 2019/0107136 A1
(43) Pub. Date: Apr. 11, 2019

(54) TOGGLE FIXING

(71) Applicant: fischerwerke GmbH & Co. KG, Waldachtal (DE)

(72) Inventor: Aaron DALY, Pfalzgrafenweiler (DE)

(21) Appl. No.: 16/139,012

(22) Filed: Sep. 22, 2018

(30) Foreign Application Priority Data
Oct. 11, 2017 (DE) 10 2017 123 655.4

(51) Int. Cl. F16B 13/08

(52) U.S. Cl. CPC F16B 13/0808

(57) ABSTRACT

A toggle fixing for fixing an article to a thin-walled component, having a crosspiece and a strip for holding the crosspiece during mounting, wherein the crosspiece has an opening for receiving a screw, with two counterbearing elements made of metal for better hold of the screw. In order to prevent certain screws from becoming jammed between the counterbearing elements, the a plastics body is arranged on each of the counterbearing elements on the side thereof facing towards the strip, which plastics body is movably joined to the crosspiece and narrows the opening.

### CROSS-REFERENCE TO RELATED APPLICATIONS

This application claims priority under 35 USC § 119 to German Patent Application No. 10 2017 123 655.4, filed on Oct. 11, 2017, the entire disclosure of which is incorporated herein by reference.

### TECHNICAL FIELD

The invention relates to a toggle fixing.

### BACKGROUND ART

A generic toggle fixing is known from the specification DE 10 2015 116 421 A1. The toggle fixing is used for fixing an article to a thin-walled component, for example to a plasterboard panel, as used in dry walling for producing walls and for cladding ceilings. A “thin-walled” component can, however, also be the wall of a vertically perforated brick or the wall of an item of ceramic sanitaryware, this list not being exhaustive. In the installed state, the rear side of the component is usually not accessible, but there is a cavity behind the component. If the component is, for example, a plasterboard panel and an article is to be fixed thereto, first of all a hole is drilled through the plasterboard panel and a crosspiece of the toggle fixing is introduced through the drilled hole into the cavity behind the panel. In the case of the toggle fixing known from the specification DE 10 2015 116 421 A1, the crosspiece is a substantially cylindrical element made of plastics which is elongated along a crosspiece longitudinal axis and has in the centre a transversely extending opening with an internal thread for receiving a screw. A strip is joined integrally to the crosspiece, which strip is resiliently and/or plastically flexible. The strip is thereby pivotally connected to the crosspiece. By virtue of the pivotal connection, the crosspiece can be tilted relative to the strip so that it can be passed through a drilled hole in the thin-walled component and tilted again in the cavity behind the component and brought to rest against the rear side of the component. In the end position, an article can be mounted on the component and attached with a screw to the crosspiece of the toggle fixing and accordingly to the component.

In order that screws having an external diameter smaller than the internal diameter of the opening can also be fixed to the crosspiece, the specification DE 10 2015 116 421 A1 proposes that there be arranged on the crosspiece at least one counterbearing element the spacing of which from the opening longitudinal axis is less than half the internal diameter of the opening.

It has been found, however, that if the crosspiece and the counterbearing element are rigidly constructed, it can happen in the case of some screws that the end of the counterbearing element facing towards the screw does not adapt to the geometry of the screw like a spring tongue, but instead bears against the core of the screw thread similarly to a locking device and generates high frictional forces. This can also be described as the counterbearing element becoming jammed against the core of the screw. The jamming can have the result that the crosspiece rotates together with the screw, so that the screw cannot be screwed further into the opening and the toggle fixing accordingly cannot fulfil its function.

### SUMMARY

An object of the invention is therefore to make the known toggle fixing more flexible in respect of the screws used and to enable the crosspiece and the counterbearing element at the same time to be of rigid construction.

The toggle fixing according to the invention for fixing an article to a thin-walled component, for example to a plasterboard panel, has a crosspiece for engaging behind the component and a strip which is joined to the crosspiece. The strip serves for holding and positioning the crosspiece during mounting, that is to say during the creation of a fixing arrangement consisting of the toggle fixing, an article and a thin-walled component. The strip is especially elongated, especially produced from plastics and can have a toothed rack. The strip is especially inherently resistant to bending, but movably attached to the crosspiece. In particular, for insertion into a drilled hole the crosspiece can be tilted relative to the strip. In addition, a sleeve can be arranged on the strip, which sleeve can be moved along the strip towards the crosspiece and, to fix the crosspiece in place, inserted into the drilled hole and clamped against the component. For that purpose the strip can have locking elements which are in operative connection with a toothed rack of the strip. Such a sleeve is not subject matter of the invention, however.

The crosspiece is especially elongated along a crosspiece longitudinal axis, that is to say it can be circumscribed by a body, especially by a parallelepiped, which in one dimension, the length in the direction of the crosspiece longitudinal axis, is larger by a multiple than in the other two dimensions. The two other dimensions are the height and the width, which run orthogonally to one another and orthogonally to the crosspiece longitudinal axis. The crosspiece has an opening for receiving a screw, which opening is especially configured as a through-opening. The opening extends along an opening longitudinal axis transversely with respect to the crosspiece longitudinal axis, especially substantially orthogonally with respect to the crosspiece longitudinal axis. When, in the installed state, the crosspiece of the toggle fixing is located in an end position in a cavity behind the component, the opening longitudinal axis is oriented in the direction of the height of the crosspiece in such a way that the screw can be inserted through the component, especially through a drilled hole in the component, into the opening. The screw, for example a wood screw or a screw having a metric thread, can be secured in the opening. In particular, the opening has an internal thread for that purpose.

In order to be able to receive different screws and especially metric screws, there is arranged on the crosspiece at least one counterbearing element made of metal for engagement in the thread of the screw. In particular, the crosspiece has a main body made of plastics, with the result that additional functions, such as, for example, an expansion function in solid building materials (see the specification DE 10 2015 113 332 A1), can be implemented more easily than in metal. In contrast, the counterbearing element made of metal is able, especially in the case of a small area of contact in the thread of a metric screw, to transmit high forces. The counterbearing element is especially planar and especially made of a sheet metal. In particular, the counterbearing element is a stamped and bent component. In order to be able to grip screws having a small thread diameter, the counterbearing is arranged so that it narrows the opening. “Narrow” means that an inside width of the opening, measured transversely with respect to the opening longitudinal axis, is at least at a different location of the opening greater than in the region of the counterbearing element. Relative to the longitudinal extent of the opening, the counterbearing element can be located inside the opening, at the end or in a notional extension thereof on the side of the opening remote from the strip. The “side facing towards the strip” means that side from which the strip extends away from the crosspiece when the strip is perpendicular to the crosspiece, that is to say especially in the installed state of the toggle fixing. What is important, therefore, is not the location at which the strip is attached to the crosspiece, but the direction in which the strip extends. Preferably, however, the strip is attached to the crosspiece also on the side thereof on which the strip extends away from the crosspiece. That side can also be referred to as the “supporting side”, because in the installed state it is typically that side of the crosspiece which comes into contact with the component. The “side remote from the strip” is the side of the crosspiece located opposite the side facing towards the strip.

The toggle fixing according to the invention is characterised by a plastics body which is arranged on the side of the counterbearing element facing towards the strip and which is movably joined to the crosspiece, especially via a rib or a film hinge, and narrows the opening. The plastics body is especially integral with a main body of the crosspiece. Here too “narrow” means that an inside width of the opening, measured transversely with respect to the opening longitudinal axis, is at least at a different location of the opening greater than in the region of the plastics body. Preferably the plastics body narrows the opening to a greater extent than does the counterbearing element. The reverse case is also a possibility, however. The plastics body is especially arranged in such a way that, prior to the insertion of a screw into the opening, it is either already in contact with the counterbearing element or its distance from the counterbearing element is so small that it makes contact with the counterbearing element at the latest when the screw finds purchase on the counterbearing element. “Movably” means a resilient or resilient-plastic deformation of the rib or the film hinge in such a way that, on insertion of a screw, the plastics body moves in the direction of or with the counterbearing element. The plastics body has the effect that the screw, on being screwed in, is able to press the counterbearing element obliquely away via the plastics body. “Obliquely” means in a direction between the opening longitudinal axis and the crosspiece longitudinal axis, especially at an angle of approximately 45 degrees with respect to the opening longitudinal axis. The screw especially first comes into contact with the plastics body and also engages in the plastics body with its thread. This increases the area of contact of the screw, i.e. prevents point contact of the counterbearing element with the core of the screw, with the result that the counterbearing element is prevented from being jammed against the core of the screw. As the screw is screwed in further, the plastics element is especially displaced outwards radially by the screw so that the counterbearing element comes into direct contact with the thread of the screw and thereby achieves a secure hold.

Preferably the counterbearing element and the plastics body are arranged on the side of the crosspiece remote from the strip. In the case of the counterbearing element this means that especially its end facing towards the opening is arranged on the side of the crosspiece remote from the strip. Other parts, and especially an opposite end, of the counterbearing element can also extend as far as the side of the crosspiece facing towards the strip. As a result of such an arrangement of the counterbearing element, in the installed state, that is to say in a fixing arrangement, tensile forces can be dissipated from the screw via the counterbearing element obliquely to the supporting side of the crosspiece. The forces are therefore well distributed over the surface of the crosspiece that is in contact with the thin-walled component, which has an advantageous effect on the maximum possible loads. The plastics element is accordingly also arranged on the side of the crosspiece remote from the strip, because, as described above, it is in contact therewith when a screw is screwed in.

In order to facilitate introduction of a screw in a straight line and good distribution of the arising forces, preferably two counterbearing elements and two plastics bodies are arranged on the crosspiece, especially symmetrically with respect to a plane or axis. In particular, the counterbearing elements and the plastics bodies are substantially symmetrical with respect to the opening longitudinal axis.

In a preferred embodiment, the plastics body has two surfaces, namely a first surface, which faces towards the counterbearing element, and a second surface, which faces away from the counterbearing element. The second surface encloses a smaller angle with the opening longitudinal axis than does the first surface. The first surface makes direct contact with the counterbearing element, at the latest when a screw is screwed in, whereas the screw comes into contact with the second surface. As a result of the smaller angle, the screw can readily move along the plastics body and especially also cut a counter-contour for threads. The plastics body can also be thought of as a kind of “wedge” which is positioned between the screw and the counterbearing element and effects a bending away of the counterbearing element obliquely to the side.

Preferably the toggle fixing has a screw such that, on being screwed into the opening, the thread of the screw first cuts into the plastics body and then enters into engagement with the counterbearing element. The cutting-in has a gentle driving-in effect, because the screw need not be pushed from the direction of its head but finds purchase in the toggle fixing. By engagement with the counterbearing element made of metal, it obtains a secure, rigid hold.

### BRIEF DESCRIPTION OF THE DRAWINGS

The invention is explained below with reference to an exemplary embodiment. In the drawings:

FIG. 1 is a perspective view of the toggle fixing according to the invention without a screw;

FIG. 2 is a sectional view of the crosspiece of the same toggle fixing on insertion of a screw;

FIG. 3 is a view of a detail from FIG. 2;

FIG. 4 is a perspective view of a detail of a main body with plastics bodies of the same toggle fixing; and

FIG. 5 is a plan view of a detail of the same main body with the plastics bodies.

### DETAILED DESCRIPTION

The toggle fixing 1 according to the invention, shown in the Figures, for fixing an article (not shown) to a thin-walled component, for example a plasterboard panel (not shown), has a substantially cylindrical crosspiece 2, a strip 3 integrally joined to the crosspiece 2, and a sleeve 4 made of plastics which is arranged on the strip 3.

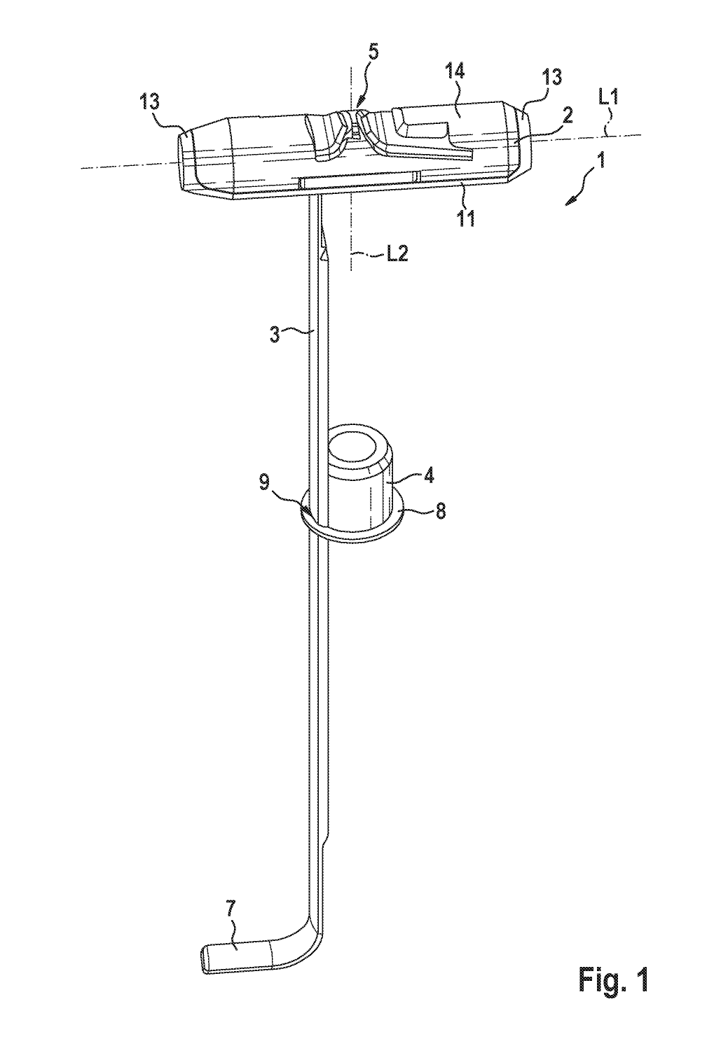

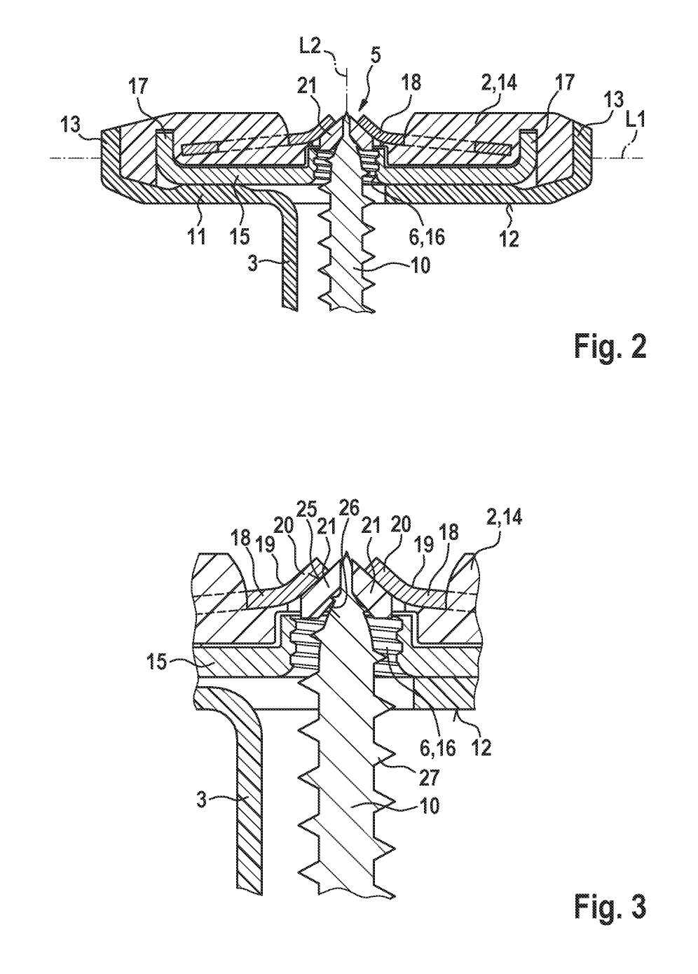

The crosspiece 2 serves for engaging behind the thin-walled component. It extends along a crosspiece longitudinal axis L1 and has in the centre an opening 5 having an internal thread 6 (see FIGS. 2 and 3), which will be discussed in greater detail hereinbelow. The opening 5 extends along an opening longitudinal axis L2 which runs perpendicularly to the crosspiece longitudinal axis L1. In other words, the opening 5 passes transversely through the crosspiece 2. The strip 3 is attached to the crosspiece 2 next to the opening 5 and in the relaxed state (not shown) extends parallel to the opening longitudinal axis L2, that is to say perpendicular to the crosspiece longitudinal axis L1. The strip 3 is resiliently deformable, with the result that the crosspiece 2 is pivotable relative to the strip 3. Since the strip 3 extends as far as the crosspiece 2, strictly speaking the crosspiece 2 is not pivotable relative to the strip 3 as a whole, but only relative to the main extent thereof. On a side facing towards the opening longitudinal axis L2, the strip 3 has tooth elements (not visible in FIG. 1) which are arranged one behind the other along the longitudinal extent of the strip 3. At its end remote from the crosspiece 2 the strip 3 has a grip element 7. The sleeve 4 has a cylindrical main body with a peripherally projecting collar 8. A through-opening 9 for the strip 3 passes through the collar 8. A resilient lug (not shown) projects in front of the through-opening 9. The strip 3 is guided past the resilient lug through the through-opening 9, so that the resilient lug engages in the tooth elements. The tooth elements and the resilient lug are constructed so that the sleeve 4 can be pushed towards the front relative to the strip 3, but not towards the rear again. Should displacement towards the rear be necessary for the purpose of correcting the mounting, the tooth elements and the resilient lug can be disengaged by tilting the sleeve 4 (not shown), but this is not material to the invention.

To produce a fixing arrangement with the toggle fixing 1, first of all a hole is drilled in the thin-walled component. The toggle fixing 1 is then inserted into the drilled hole, with the crosspiece 2 to the front (not shown). For that purpose the crosspiece 2 is pivoted relative to the strip 3. As soon as the crosspiece 2 has passed fully through the drilled hole, the resilience of the strip 3 causes the crosspiece to pivot back into its starting position, that is to say it is perpendicular to the strip 3 again. Using the strip 3, the crosspiece 2 is pulled against the inaccessible rear side of the thin-walled component, and the sleeve 4 is pushed along the strip 3 towards the front into the drilled hole until the collar 8 rests on a front side of the thin-walled component (not shown). During that operation the strip 3 serves for holding and positioning the crosspiece 2. The protruding end of the strip 3 can then be cut off or broken off and the article being fixed mounted on the collar 8 (not shown). The actual fixing of the article is carried out using a screw 10, which will be discussed in greater detail in connection with the description of FIGS. 2 and 3. The screw 10 is passed through a receiving hole or the like in the article and through the sleeve 4 as far as the crosspiece 2 and is screwed into the opening 5 in the crosspiece 2.

In FIG. 2 the longitudinal section through the crosspiece 2 shows how the latter is constructed. The crosspiece 2 has on its side facing towards the strip, which is referred to hereinbelow as the supporting side, a planar supporting element 11 made of plastics which forms a contact surface 12 for contact with the rear side of the thin-walled component. Discs 13, each perpendicular to the contact surface 12, enclose a main body 14 made of plastics, so that the main body 14 extends between the discs 13 on a side of the supporting element 11 remote from the strip 3. The discs 13 form the two ends of the crosspiece 2. The supporting element 11 merges integrally into the strip 3.

A metal core 15 extends parallel to the crosspiece longitudinal axis L1 between the supporting element 11 and the main body 14. The metal core 15 has been shaped from a steel sheet, has in the centre a threaded rim hole 16 having the internal thread 6, and a short turned-up edge 17 at both ends. The metal core 15 is slightly shorter than the main body 14 and is arranged and constructed so as to be substantially symmetrical with respect to the opening longitudinal axis L2.

On a side of the metal core 15 remote from the strip 3, two counterbearing elements 18 made of metal are arranged symmetrically with respect to the opening longitudinal axis L2. Starting approximately from the turned-up edges 17, the counterbearing elements 18 first extend in the direction of the opening 5 at a shallow angle with respect to the crosspiece longitudinal axis L1. Approximately in the region of the threaded rim hole 16, the counterbearing elements 18 form a slight bending edge 19 and run at a larger angle than previously with respect to the crosspiece longitudinal axis L1. In that region the counterbearing elements 18 form tongues 20 which taper towards the opening longitudinal axis L2 (see FIG. 1). The counterbearing elements 18 narrow the opening 5. An inside width of the opening 5, seen in the direction of the opening longitudinal axis L2, is smaller in the region of the counterbearing elements 18 than in the region of the internal thread 6.

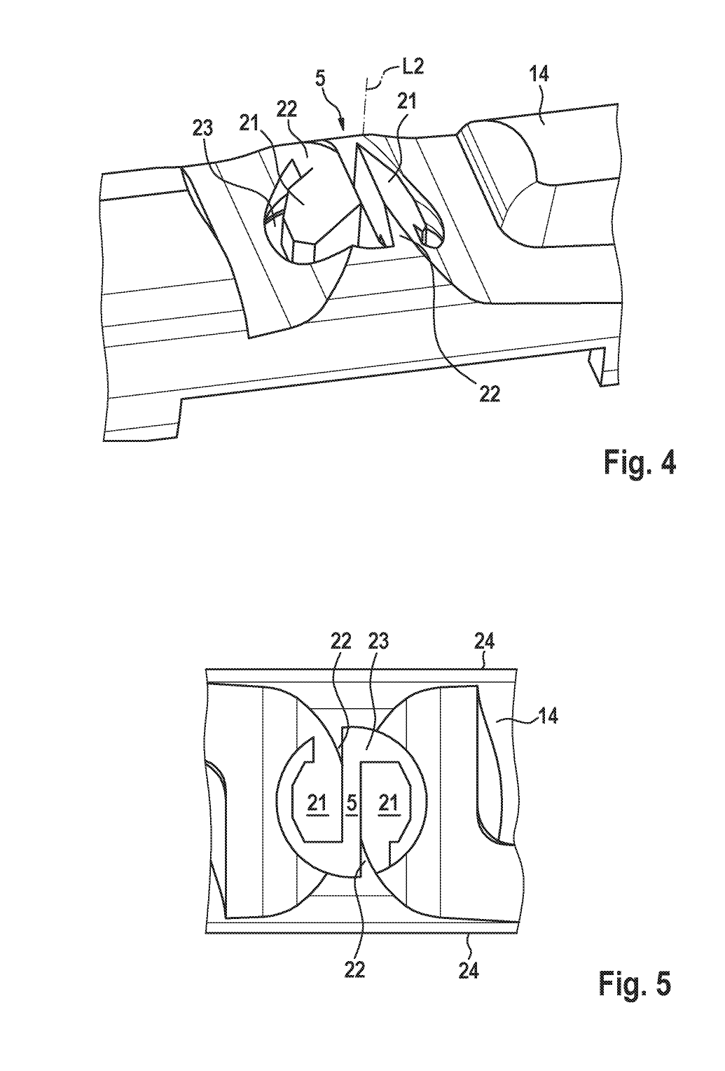

A plastics body 21 is arranged on each of the tongues 20 on the side thereof facing towards the strip 3. The plastics bodies 21 are here not considered part of the crosspiece 2 but are integrally joined to the main body 14 via ribs 22. As can be seen in FIGS. 4 and 5, the ribs 22 project from a circular recess 23, which forms a part of the opening 5, tangentially into the recess 23. The ribs 22 each extend perpendicularly from one of the longitudinal sides 24. The “longitudinal sides 24” here denote the sides along the crosspiece longitudinal axis L1 which neither form the contact surface 12 nor are remote therefrom. The plastics bodies 21 are approximately semi-circular in the plan view shown in FIG. 5 and approximately wedge-shaped in the cross-section shown in FIGS. 2 and 3. As a result, the plastics bodies 21 each have a first surface 25, which faces towards the counterbearing element 18, and a second surface 26, which faces away from the counterbearing element 18. Prior to the introduction of the screw 10, the second surface 26 is in contact with the respective tongue 20 and encloses a smaller angle with the opening longitudinal axis L2 than does the first surface 25. In the region of the plastics bodies 21, the opening 5 therefore tapers more sharply that would be the case only as a result of the tongues 20 without the plastics bodies 21. The plastics bodies 21 are arranged inside the recess 23 so that an inside width is smaller in this region of the opening 5 than in the region of the counterbearing elements 18. The plastics bodies 21 therefore narrow the opening 5 to a greater extent than do the counterbearing elements 18. By virtue of the ribs 22, the plastics bodies 21 are movably connected to the crosspiece 2 and can therefore yield in a direction opposite to the strip.

If the screw 10 of the toggle fixing 1 is inserted into the opening 5 by rotation, as shown in FIGS. 2 and 3, the screw 10 can with its thread 27 very easily cut a counter-thread in the region of the second surfaces 26. On further screwing-in, the plastics bodies 21 are displaced by the screw 10 in a direction oblique with respect to the opening longitudinal axis L2. With their first surfaces 25 the plastics bodies 21 press the tongues 20 of the counterbearing elements 18 likewise in a direction oblique with respect to the opening longitudinal axis L2. By further screwing-in, the plastics bodies 21 slide under the tongues 20 and the thread 27 enters into direct engagement with the tongues 20 of the counterbearing elements 18. If a tensile force is applied to the screw 10 in a direction opposite to the screwing-in direction, the thread 27 transfers that tensile force to the counterbearing elements 21 which transmit the force along their extent and distribute it via the metal core 15 to the length of the crosspiece 2.

### LIST OF REFERENCE SYMBOLS

1 toggle fixing
2 crosspiece
3 strip
4 sleeve
5 opening
6 internal thread
7 grip element
8 collar of the sleeve 4
9 through-opening of the sleeve 4 for the strip 3
10 screw
11 supporting element
12 contact surface
13 disc
14 main body
15 metal core
16 threaded rim hole
17 turned-up edge
18 counterbearing element
19 bending edge
20 tongue
21 plastics body
22 rib
23 recess
24 longitudinal side of the crosspiece 2
25 first surface of the plastics body 21, facing towards the counterbearing element 18
26 second surface of the plastics body 21, facing away from the counterbearing element 18
27 thread of the screw 10
L1 crosspiece longitudinal axis
L2 opening longitudinal axis

1. A toggle fixing for fixing an article to a thin-walled component, comprising:
a crosspiece and a strip which is joined to the crosspiece and serves for holding the crosspiece during mounting, wherein the crosspiece extends along a crosspiece longitudinal axis, and
wherein the crosspiece has an opening for receiving a screw, the opening extending along an opening longitudinal axis transversely with respect to the crosspiece longitudinal axis,
wherein on the crosspiece there is arranged at least one counterbearing element made of metal for engagement in the thread of the screw, which element narrows the opening, and
wherein on the side of the counterbearing element facing towards the strip there is arranged a plastics body which is movably joined to the crosspiece and narrows the opening.

2. The toggle fixing according to claim 1, wherein the counterbearing element and the plastics body are arranged on a side of the crosspiece remote from the strip.

3. The toggle fixing according to claim 1, wherein the toggle fixing has at least two counterbearing elements and two plastics bodies which are arranged symmetrically with respect to a plane or axis.

4. The toggle fixing according to claim 1, wherein the plastics body has a first surface, which faces towards the counterbearing element, and a second surface, which faces away from the counterbearing element, and the second surface encloses a smaller angle with the opening longitudinal axis than does the first surface.

5. The toggle fixing according to claim 1, wherein the plastics body narrows the opening to a greater extent than does the counterbearing element.

6. The toggle fixing according to claim 1, wherein the toggle fixing has a screw such that, on being screwed into the opening, the thread of the screw first cuts into the plastics body and then enters into engagement with the counterbearing element.

7. The toggle fixing according to claim 1, wherein the plastics body is movably joined to the crosspiece via a rib.

8. The toggle fixing according to claim 1, wherein the plastics body is movably joined to the crosspiece via a film hinge.
